(19) United States
(12) Patent Application Publication
(10) Pub. No.: US 2012/0318444 A1
(43) Pub. Date: Dec. 20, 2012

(54) METHOD FOR MANUFACTURING THREE-DIMENTIONAL WORKPIECE

(75) Inventors: Jung-Chin Wu, Taipei City (TW); Po-An Lin, Taipei City (TW); Han-Ching Huang, Taipei City (TW)

(73) Assignee: COMPAL ELECTRONICS, INC., Taipei City (TW)

(21) Appl. No.: 13/517,542

(22) Filed: Jun. 13, 2012

Related U.S. Application Data
(60) Provisional application No. 61/497,033, filed on Jun. 14, 2011.

(51) Int. Cl. B32B 37/02

(52) U.S. Cl. 156/221

(57) ABSTRACT

A method for manufacturing a three-dimensional workpiece is provided. In this method, a ductile plate, a core layer and a prepreg are combined to form a sandwich structure. The core layer is located between the ductile plate and the prepreg. The sandwich structure is shaped to be the three-dimensional sandwich structure. The sandwich structure is heated to cure the prepreg.

### CROSS-REFERENCE TO RELATED APPLICATION

This application claims the priority benefit of U.S. provisional application Ser. No. 61/497,033, filed on Jun. 14, 2011. The entirety of the above-mentioned patent application is hereby incorporated by reference herein and made a part of this specification.

### BACKGROUND OF THE INVENTION

1. Field of the Invention

The present invention relates to a method for manufacturing a three-dimensional workpiece, and more particularly, to a method for manufacturing a three-dimensional workpiece with a composite material.

2. Description of Related Art

With the advancement in semiconductor devices and display technology, electronic products are being developed toward small size, multi-function and ease of carry. Common portable electronic products include notebook computers, tablet computers and mobile phones.

In order to reduce weight and increase structural strength of casings of the portable electronic products, an existing method is using a composite material of fiber and metal to manufacture the casings. In manufacturing the casings with the composite material of fiber and metal, a flat metal plate is three-dimensionally shaped into a three-dimensional metal workpiece. A prepreg then overlies on a surface of the three-dimensional metal workpiece and the prepreg is cured.

### SUMMARY OF THE INVENTION

Accordingly, the present invention is directed to a method for manufacturing a three-dimensional workpiece.

The present invention provides a method for manufacturing a three-dimensional workpiece. In this method, a ductile plate, a core layer and a prepreg are combined to form a sandwich structure. The core layer is located between the ductile plate and the prepreg. The sandwich structure is shaped to be a three-dimensional sandwich structure. The three-dimensional sandwich structure is then heated to cure the prepreg.

In view of the foregoing, the ductile plate, core layer and prepreg are combined to form the sandwich structure. The three-dimensional sandwich structure is then shaped and the prepreg is cured to form a three-dimensional workpiece.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A to FIG. 1C illustrate a method for manufacturing a three-dimensional workpiece according to one embodiment of the present invention.

FIG. 2 is an enlarged view of an encircled portion 2 of FIG. 2A.

FIG. 3 illustrates multiple sandwich structures of FIG. 1A formed into a roll.

### DESCRIPTION OF THE EMBODIMENTS

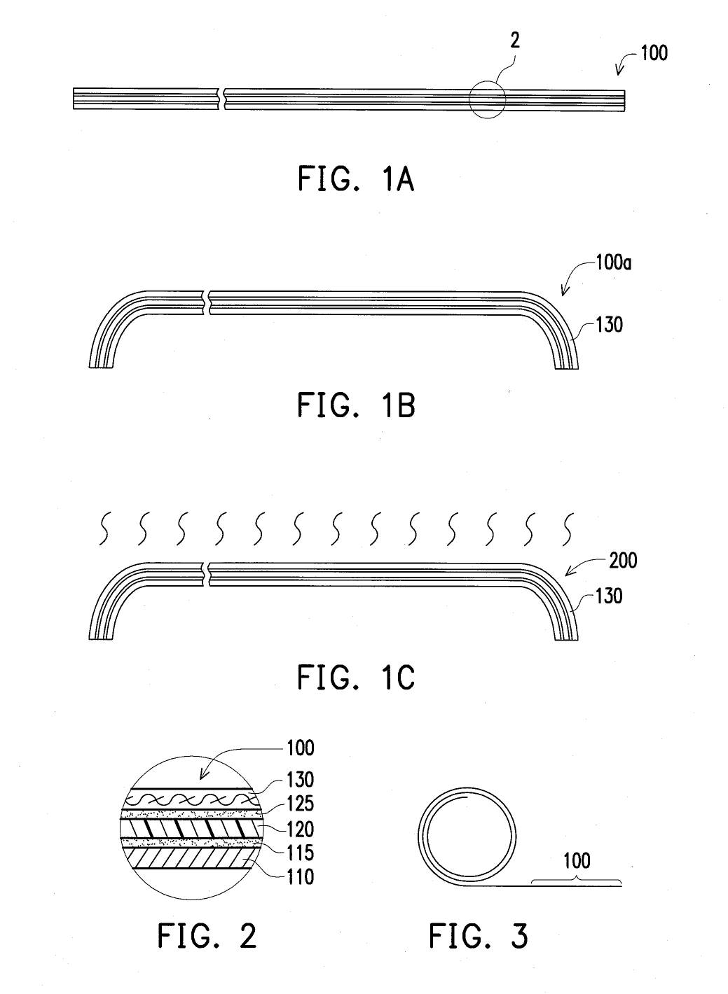

FIG. 1A to FIG. 1C illustrate a method for manufacturing a three-dimensional workpiece according to one embodiment of the present invention, and FIG. 2 is an enlarged view of an encircled portion 2 of FIG. 2A. Referring to FIG. 1A and FIG. 2, a ductile plate 110, a core player 120, and a prepreg 130 are combined to form a sandwich structure 100, with the core layer 120 being located between the ductile plate 110 and the prepreg 130. The ductile plate 110 may be a metal plate or a ductile material plate containing metal.

Depending on different product designs, the core layer 120 may be formed of multiple material layers or a single material layer. In addition, in accordance with outer appearance and strength requirements of products, the core layer 120 may have a uniform thickness or a non-uniform thickness. Likewise, the ductile plate 110 may have a uniform thickness or a non-uniform thickness, and the prepreg 130 may have a uniform thickness or a non-uniform thickness.

In the step of combining the ductile plate 110, the core layer 120 and the prepreg 130, the core layer 120 may be adhered to the ductile plate 110, and the prepreg 130 is then adhered to the core layer 120. However, the present invention is not intended to be limited to the particular embodiment described herein.

In the step of combining the ductile plate 110 and the core layer 120, an adhesive layer 115 may be used to adhere the ductile plate 110 and the core layer 120 together. The adhesive layer 115 may be formed by coating an adhesive material on the ductile plate 110 or on the core layer 120.

In the step of combining the core layer 120 and the prepreg 130, an adhesive layer 125 may be used to adhere the core layer 120 and the prepreg 130 together. The adhesive layer 125 may be formed by coating an adhesive material on the core layer 120 or on the prepreg 130.

In another embodiment, the core layer 120 and the prepreg 130 may be combined by a pre-impregnated liquid on a surface of the prepreg 130, without the need of additional adhesive layer. The pre-impregnated liquid on the surface of the prepreg 130 includes epoxy resin. In addition, if the core layer 120 has an opening, the process of manufacturing the three-dimensional structure does not need additional adhesive layer. When the core layer 120 has an opening, the core layer 120 and the prepreg 130 may be first combined using the pre-impregnated liquid on the surface of the prepreg 130. The pre-impregnated liquid may be distributed to the other side of the core layer 120 via the opening of the core layer 120. Then, in combining the ductile plate 110 with the core layer 120, the ductile plate 110 may be combined with the core layer 120 to form the three-dimensional structure only by the pre-impregnated liquid, without the need of additional adhesive layer.

In this embodiment, when the ductile plate 110 is a metal plate, the metal plate may be tin-plated steel plate (SPTE), aluminium plate, or stainless steel plate (SUS plate). A material of the core layer 120 may be plastic, plant fiber, carbon fiber, glass fiber, or graphite. The prepreg 130 is formed of a fiber cloth impregnated with a resin. The fiber cloth of the fiber prepreg 130 may be carbon fiber, plant fiber, or glass fiber.

Referring to FIG. 1B, after the sandwich structure 100 of FIG. 1A is formed, the sandwich structure 100 is shaped to be a three-dimensional sandwich structure 100a.

In the present embodiment, the sandwich structure 100 may be shaped by stamping.

Referring to FIG. 1C, after the sandwich structure 100 is shaped to be the three-dimensional sandwich structure 100a, the prepreg 130 is cured such that the three-dimensional sandwich structure 100a becomes a three-dimensional workpiece 200 (e.g. a casing of an electronic device). Curing the prepreg 130 is to cure the semi-cured resin part of the prepreg 130. In the present embodiment, the prepreg 130 may be cured in a thermosetting manner.

If the sandwich structure 100 of FIG. 1A is shaped by stamping, the prepreg 130 may be cured by heat conducted from a stamp mold to the prepreg 130. After the sandwich structure 100 of FIG. 1A is shaped to be the three-dimensional sandwich structure 100a of FIG. 1B, the three-dimensional sandwich structure 100a may further be disposed in a heating device to undergo a heating process for curing the prepreg 130, according to actual designs of the manufacturing process.

Notably, in the step of forming the sandwich structure 100 of FIG. 1A, the ductile plate 110, core layer 120 and prepreg 130 are usually each cut into pieces with a desired size and then assembled to form the sandwich structure 100. However, according to actual designs of the manufacturing process, multiple sandwich structures 100 may be formed into a roll as shown in FIG. 3. In the step of shaping the sandwich structure 100 of FIG. 1A, the roll of the sandwich structures 100 is cut up into individual sandwich structures 100 which are then unrolled for shaping to be the three-dimensional sandwich structures 100a of FIG. 1B.

In summary, in the present invention, the ductile plate, core layer and prepreg are combined to form the sandwich structure. The three-dimensional sandwich structure is then shaped and the prepreg is cured to form a three-dimensional workpiece. In addition, the present invention may be carried out in combination with a rolling process at a pre-production stage to increase productivity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for manufacturing a three-dimensional workpiece, comprising:
combining a ductile plate, a core layer and a prepreg to form a sandwich structure, wherein the core layer is located between the ductile plate and the prepreg;
shaping the sandwich structure to be a three-dimensional sandwich structure; and
heating the three-dimensional sandwich structure to cure the prepreg.

2. The method for manufacturing the three-dimensional workpiece according to claim 1, wherein in the step of forming the sandwich structure, the sandwich structure is formed into a roll, and in the step of shaping the sandwich structure, the roll of the sandwich structure is unrolled for shaping the sandwich structure.

3. The method for manufacturing the three-dimensional workpiece according to claim 1, wherein in the step of combining the ductile plate, the core layer and the prepreg, the core layer is adhered to the ductile plate and the prepreg is then adhered to the core layer, and in the step of combining the ductile plate and the core layer, an adhesive layer is used to adhere the ductile plate and the core layer together.

4. The method for manufacturing the three-dimensional workpiece according to claim 1, wherein in the step of combining the ductile plate, the core layer and the prepreg, the core layer is adhered to the prepreg, and the ductile plate is then adhered to the core layer.

5. The method for manufacturing the three-dimensional workpiece according to claim 4, wherein the core layer has multiple openings, and a pre-impregnated liquid of the prepreg is used to combine the prepreg and the core layer, and combine the core layer and the ductile plate.

6. The method for manufacturing the three-dimensional workpiece according to claim 1, wherein in the step of shaping the sandwich structure, the sandwich structure is shaped by stamping.

7. The method for manufacturing the three-dimensional workpiece according to claim 1, wherein in the step of curing the prepreg, the prepreg is cured in a thermosetting manner.

8. The method for manufacturing the three-dimensional workpiece according to claim 7, wherein in the step of curing the prepreg, a mold used for shaping the sandwich structure is heated to cure the prepreg.

9. The method for manufacturing the three-dimensional workpiece according to claim 1, wherein the ductile plate is a metal plate or a ductile material plate containing metal.

10. The method for manufacturing the three-dimensional workpiece according to claim 9, wherein the metal plate is SPTE, aluminium plate, or SUS plate.

11. The method for manufacturing the three-dimensional workpiece according to claim 1, wherein a material of the core layer is plastic, plant fiber, carbon fiber, glass fiber, or graphite.

12. The method for manufacturing the three-dimensional workpiece according to claim 1, wherein the fiber of the prepreg is carbon fiber, plant fiber, or glass fiber.

13. The method for manufacturing the three-dimensional workpiece according to claim 1, wherein the core layer has a non-uniform thickness and is formed of multiple material layers or a single material layer.

14. The method for manufacturing the three-dimensional workpiece according to claim 1, wherein the ductile plate has a non-uniform thickness.

15. The method for manufacturing the three-dimensional workpiece according to claim 1, wherein the prepreg has a non-uniform thickness.
